(19) United States
(12) Patent Application Publication
(10) Pub. No.: US 2026/0074414 A1
(43) Pub. Date: Mar. 12, 2026

(54) ANTENNA AND ELECTRONIC DEVICE

(71) Applicant: Honor Device Co., Ltd., Shenzhen (CN)

(72) Inventors: Shaojie CHU, Shenzhen (CN); Aofang ZHANG, Shenzhen (CN); Yiwu HU, Shenzhen (CN); Ning MA, Shenzhen (CN); Shichao LI, Shenzhen (CN)

(21) Appl. No.: 19/389,527

(22) Filed: Nov. 14, 2025

Related U.S. Application Data
(63) Continuation of application No. PCT/CN2024/079025, filed on Feb. 28, 2024.

(30) Foreign Application Priority Data
May 22, 2023 (CN) 202310583314.8

(51) Int. Cl. H01Q 1/24; H01Q 5/328

(52) U.S. Cl. CPC H01Q 1/243; H01Q 5/328

(57) ABSTRACT

This application discloses an antenna and an electronic device, and relates to the field of antenna technologies. The antenna is used in the electronic device. The electronic device includes a metal back housing, a metal middle frame, and a metal screen substrate. A first window is formed between the screen substrate and the metal middle frame, and a second window is provided on the metal back housing. A first ground terminal, a feed terminal, and a second ground terminal are disposed on the screen substrate, the feed terminal is located between the first ground terminal and the second ground terminal, and projections of the first ground terminal, the feed terminal. The first ground terminal, the feed terminal, and the second ground terminal are connected to the metal back housing by using metal connectors respectively.

### CROSS-REFERENCE TO RELATED APPLICATIONS

This application is a continuation of International Application No. PCT/CN2024/079025, filed on Feb. 28, 2024, which claims priority to Chinese Patent Application No. 202310583314.8, filed on May 22, 2023, both of which are incorporated herein by reference in their entireties.

### TECHNICAL FIELD

This application relates to the field of antenna technologies, and in particular, to an antenna and an electronic device.

### BACKGROUND

Currently, a mainstream tablet computer in the market generally uses a metal rear cover. Such a metal rear cover is more popular with users because of good tactile and visual effects. However, a metal material of the rear cover limits radiation performance of an antenna in the tablet computer.

Therefore, currently, the following manners are mainly used for antenna design of a tablet computer terminal: (1) A slot is cut in the metal rear cover of the tablet computer, or a part of metal is cut off to form a “window”, to form a specific radiation space for the antenna. (2) A cavity space inside a body of the terminal is used to perform radiation by using a cavity antenna. However, when the foregoing solution (1) is used, a metal slot or “window” is cut in the metal rear cover of the tablet computer, which severely affects aesthetics of a body and reduces competitiveness of a product. When the foregoing solution (2) is used, although a beautiful appearance of the product is not affected, antenna radiation directionality of the solution is strong, and costs are high.

### SUMMARY

This application provides an antenna and an electronic device. The antenna may perform energy radiation by using a window formed in a non-display region in front of a screen in the electronic device and a window provided on a rear housing of the electronic device for placing a camera module. A slot or a window does not need to be provided on the rear housing of the electronic device, which does not affect aesthetics of the electronic device. In addition, the antenna of this application has advantages such as low costs, a low directivity factor, high efficiency, and being not affected by the camera module.

To achieve the foregoing objectives, the following technical solutions are used in embodiments of this application.

According to a first aspect, this application provides an antenna, used in an electronic device, where the electronic device includes a metal back housing, a metal middle frame, and a screen substrate. The screen substrate is a metal plate, the metal back housing is connected to the metal middle frame, the screen substrate is located in the metal middle frame and has a first spacing with the metal middle frame, the screen substrate has a second spacing with the metal back housing, the first spacing between the screen substrate and the metal middle frame forms a first window, and a second window is provided on the metal back housing.

The metal back housing includes a first side and a second side opposite to each other, and a third side and a fourth side opposite to each other, the first side is adjacent to the third side, a region between the first side and the second window is a first region, and a region between the third side and the second window is a second region. A distance between the second window and the first side is less than a distance between the second window and the second side; and/or a distance between the second window and the third side is less than a distance between the second window and the fourth side.

A first ground terminal, a feed terminal, and a second ground terminal are disposed on the screen substrate, the feed terminal is located between the first ground terminal and the second ground terminal, and projections of the first ground terminal, the feed terminal, and the second ground terminal on the metal back housing are located in the first region and/or the second region. The first ground terminal, the feed terminal, and the second ground terminal are connected to the metal back housing by using metal connectors respectively.

In this way, the antenna is disposed at a corner at which the second window is provided on the electronic device; or the antenna is disposed between a camera module window and the metal middle frame (a middle frame closest to the camera module window) on the electronic device. Energy radiation is performed by using the second window on the metal back housing in the electronic device and the first window right in front of a screen in the electronic device. The first window may be a non-display region (a “black border” on the screen) of the electronic device, and the second window may be the camera module window on the electronic device. A hole or a groove does not need to be provided on the metal back housing of the electronic device, so that aesthetics of the electronic device can be maintained.

The first ground terminal, the feed terminal, and the second ground terminal on the screen substrate are respectively connected to the metal back housing by using metal connectors. The screen substrate is used as a ground plane, and the metal back housing is used to form a radiation unit, so that a slot differential mode antenna may be formed. The antenna has simple structures. In a specific application, three metal spring contacts may be disposed at corresponding positions on the screen substrate, so that each spring contact abuts against the metal back housing, to form the antenna of this application. Complex structures and components are not needed, and the costs are low. The antenna may perform energy radiation by using the first window and the second window, and has advantages such as a low directivity factor, high efficiency, and being not affected by a camera module.

In a possible design manner of the first aspect, the first window is a non-display region of a screen of the electronic device. In this way, an existing structure (the black border on the screen) on the electronic device may be used to cause the antenna to perform energy radiation.

In a possible design manner of the first aspect, the second window is a camera module window of the electronic device. In this way, an existing structure (the camera module window in which the camera module is mounted on the back housing) on the electronic device may be used to cause the antenna to perform energy radiation.

In a possible design manner of the first aspect, a distance between the first ground terminal and the second ground terminal is half a wavelength, one wavelength, or 1.5 wavelengths, and the wavelength is a wavelength corresponding to an operating frequency of the antenna. A distance between the feed terminal and the first ground terminal is a preset distance, or a distance between the feed terminal and the second ground terminal is a preset distance; and the preset distance is determined based on impedance matching of the antenna.

In this way, a size of the antenna (the distance between the first ground terminal and the second ground terminal) may be set, so that the antenna can operate in different frequency ranges, and the antenna can match operating frequency requirements of different electronic devices. A position of the feed terminal is set, so that the antenna can satisfy corresponding impedance matching.

In a possible design manner of the first aspect, the projections of the first ground terminal, the feed terminal, and the second ground terminal on the metal back housing are all located in the first region, and a length of the second window in a direction of the first side is greater than or equal to the distance between the first ground terminal and the second ground terminal.

In a possible design manner of the first aspect, the projections of the first ground terminal, the feed terminal, and the second ground terminal on the metal back housing are all located in the second region, and a length of the second window in a direction of the third side is greater than or equal to the distance between the first ground terminal and the second ground terminal.

In a possible design manner of the first aspect, the projections of the first ground terminal and the feed terminal on the metal back housing are located in the second region, and the projection of the second ground terminal on the metal back housing is located in the first region.

In a possible design manner of the first aspect, the projection of the first ground terminal on the metal back housing is located in the second region, and the projections of the second ground terminal and the feed terminal on the metal back housing are located in the first region.

In a possible design manner of the first aspect, the screen substrate includes a fifth side and a sixth side adjacent to each other, the fifth side corresponds to the third side, and the sixth side corresponds to the first side; and a distance between the first ground terminal and the sixth side is equal to a distance between the second ground terminal and the fifth side.

In a possible design manner of the first aspect, a first metal spring contact is disposed at the first ground terminal, and the first metal spring contact abuts against the metal back housing; a second metal spring contact is disposed at the feed terminal, and the second metal spring contact abuts against the metal back housing; and a third metal spring contact is disposed at the second ground terminal, and the third metal spring contact abuts against the metal back housing.

In a possible design manner of the first aspect, one or more fourth metal spring contacts are further disposed on the screen substrate, and the fourth metal spring contact is located on a side that is of the first metal spring contact and that is away from the second metal spring contact, and/or the fourth metal spring contact is located on a side that is of the third metal spring contact and that is away from the second metal spring contact; and the fourth metal spring contact is grounded and abuts against the metal back housing.

In a possible design manner of the first aspect, the first window is a non-display region of a screen of the electronic device.

According to a second aspect, this application provides an electronic device, including a display screen and the antenna according to the first aspect and any possible design manner thereof. The display screen is connected to the metal middle frame, and the display screen and the metal back housing are respectively located on two sides of the metal middle frame.

It may be understood that, for beneficial effects that can be achieved by the electronic device provided in the second aspect provided above, reference may be made to beneficial effects in the first aspect and any possible design manner thereof, and details are not described herein again.

### BRIEF DESCRIPTION OF DRAWINGS

FIG. 1 is a schematic structural diagram of a front surface of an electronic device according to an embodiment of this application;

FIG. 2 is a schematic structural diagram of a rear surface of an electronic device according to an embodiment of this application;

FIG. 3 is a schematic partial cross-sectional view of an electronic device in a thickness direction according to an embodiment of this application;

FIG. 4 is a schematic structural diagram of an antenna according to an embodiment of this application;

FIG. 5 is a schematic diagram of an internal structure of an electronic device according to an embodiment of this application;

FIG. 6 is a schematic diagram of a simplified model of another antenna according to an embodiment of this application;

FIG. 7 is a schematic structural diagram of another antenna according to an embodiment of this application;

FIG. 8 is a schematic diagram of a simplified model of the another antenna shown in FIG. 7 according to an embodiment of this application;

FIG. 9 is a schematic diagram of simulation of the antenna shown in FIG. 4 according to an embodiment of this application;

FIG. 10 is a schematic diagram of current simulation, pattern simulation, and electric field simulation in a Z direction of the antenna shown in FIG. 4 around 2.4 GHz;

FIG. 11 is a schematic diagram of current simulation, pattern simulation, and electric field simulation in a Z direction of the antenna shown in FIG. 4 around 4.7 GHz;

FIG. 12 is a schematic diagram of current simulation, pattern simulation, and electric field simulation in a Z direction of the antenna shown in FIG. 4 around 5.9 GHz;

FIG. 13 is a radiation aperture diagram of an electric field distribution of the antenna shown in FIG. 4 in front of a screen of an electronic device;

FIG. 14 is another schematic structural diagram of an antenna according to an embodiment of this application;

FIG. 15 is a radiation efficiency curve diagram of whether an antenna is added with a fourth spring connector according to an embodiment of this application;

FIG. 16 is a schematic structural diagram of a rear surface of another electronic device according to an embodiment of this application;

FIG. 17 is a schematic diagram of an internal structure of another antenna according to an embodiment of this application;

FIG. 18 is a schematic structural diagram of a rear surface of still another electronic device according to an embodiment of this application; and

FIG. 19 is a schematic diagram of an internal structure of still another antenna according to an embodiment of this application.

100—Electronic device;
10—Screen; 20—Metal middle frame; 30—Metal back housing; 40—Screen substrate;
11—Non—display region; 12—Display region; 13—First window;
31—Second window; 32—First side; 33—Second side; 34—Third side; 35—Fourth side; 36—First region; 37—Second region;
41—First ground terminal; 42—Feed terminal; 43—Second ground terminal; 44—First feed position; 45—Second feed position;
46—Fifth side; 47—Sixth side;
51—First ground member; 52—Feed member; 53—Second ground member; 54—Fourth metal spring contact.

### DESCRIPTION OF EMBODIMENTS

The following describes technical solutions of this application with reference to the accompanying drawings.

In embodiments of this application, words such as “exemplary” or “for example” is used to represent giving an example, an illustration, or a description. Any embodiment or design solution described as an “exemplary” or “for example” in embodiments of this application should not be explained as being more preferred or having more advantages than another embodiment or design solution. To be precise, the use of the words such as “exemplary” or “for example” is intended to present a related concept in a specific manner.

In embodiments of this application, terms “first” and “second” are used merely for a purpose of description, and shall not be understood as an indication or implication of relative importance or implicit indication of a quantity of indicated technical features. Therefore, a feature defined by “first”or “second”may explicitly or implicitly include one or more features.

It should be understood that, terms used in the descriptions of various examples in this specification are merely intended to describe specific examples, but are not intended to constitute a limitation. As used in the description of the various examples, singular forms, “one” (“a” or “an”) and “the”are intended to also include plural forms, unless otherwise explicitly indicated in the context.

In this application, “at least one” refers to one, two, or more, and “a plurality of” refers to two or more. “At least one (item) of the following” or a similar expression thereof refers to any combination of these items, including a single item or any combination of a plurality of items. For example, at least one (item) of a, b, or c may represent: a, b, c, a-b, a-c, b-c, or a-b-c, where a, b, c may be singular or plural.

It should be further understood that, the term “and/or” used in this specification refers to and includes any and all possible combinations of one or more of the associated listed items. The term “and/or” describes an association relationship for describing associated objects and represents that three relationships may exist. For example, A and/or B may represent the following three cases: Only A exists, both A and B exist, and only B exists. In addition, the character “/” in this application generally represents that an “or”relationship between the associated objects.

It should be further understood that, in this application, unless otherwise explicitly specified or defined, the term “connection” should be understood in a broad sense. For example, the “connection” may be a fastened connection, a sliding connection, a detachable connection, or an integral connection; or the “connection” may be directly connected, or an indirect connection by using an intermediary.

It should be further understood that, the terms “include” (also referred to as “includes”, “including”, “comprises”, and/or “comprising”), when used in this specification, specify the presence of stated features, integers, steps, operations, elements, and/or components, but does not preclude the presence or addition of one or more other features, integers, steps, operations, elements, components, and/or groups thereof.

It should be understood that “an embodiment”, “another embodiment”, or “a possible design manner” mentioned throughout the specification means that particular features, structures, or characteristics related to the embodiments or the implementations are included in at least one embodiment of this application. Therefore, “in an embodiment of this application” or “in another embodiment of this application” or “a possible design manner” occurs in everywhere throughout the specification does not necessarily refer to a same embodiment. In addition, the particular features, structures, or characteristics may be combined in one or more embodiments in any proper manner.

It should be further understood that, specific values mentioned in embodiments of this application are not intended to limit particular features, and specific sizes of structures. The related values may be used as an example for ease of understanding, or may be an optimal theoretical value of a feature. In practice, the related size may be a range of the value appended thereto. For example, the range may be ±10% of the optimal theoretical value, or ±20% of the optimal theoretical value, subject to that corresponding technical effects can be achieved in practice.

With the development of technologies, to focus on hand feeling and aesthetics of tablet computers, a mainstream tablet computer in the market generally uses a metal rear cover. Such a metal rear cover is more popular with users because of good tactile and visual effects. However, a metal material of the rear cover limits radiation performance of an antenna in the tablet computer.

Therefore, in a current mainstream tablet computer terminal, a manner used for antenna design is as follows: A slot is cut in a metal rear cover of the tablet computer, or a part of metal is cut off to form a “window”, to form a specific radiation space for the antenna. However, this solution damages aesthetics of the metal rear cover, affects aesthetics of an entire body and consistency of a product, and reduces competitiveness of the product.

In some other tablet computers, a form used for antenna design is as follows: A cavity space inside a body of the tablet computer is used to perform radiation by using a cavity antenna, so as to avoid providing a slot on the rear cover of the tablet computer without affecting aesthetics of the product. However, the antenna in this solution has some defects in performance, for example, the cavity antenna has strong directionality, and high costs are needed when the antenna is added inside the body.

To resolve the foregoing technical problem, an embodiment of this application provides an antenna. The antenna is used in an electronic device, and may perform radiation by using a clearance formed by a non-display region on a display screen of the electronic device and a window provided on a rear housing of the electronic device for mounting a camera module. The rear housing of the electronic device does not need to be additionally provided with a slot, so that a good appearance of the electronic device can be ensured. The antenna may perform energy radiation on both front and rear sides of the electronic device, and has a low directivity factor. In addition, the antenna further has advantages such as high efficiency, being not affected by a camera module, and low costs.

Based on the foregoing improvement idea, embodiments of this application are described in detail with reference to the accompanying drawings. Before embodiments of this application are described, an application scenario of this application is first described.

This application provides an electronic device. The electronic device 100 may be a portable electronic apparatus or another suitable electronic apparatus. For example, the electronic device 100 may be a mobile phone, a tablet personal computer (tablet personal computer), a laptop computer (laptop computer), a personal digital assistant (personal digital assistant, PDA), a camera, a personal computer, a notebook computer, a wearable device, augmented reality (augmented reality, AR) glasses, an AR helmet, virtual reality (virtual reality, VR) glasses, a VR helmet, or the like.

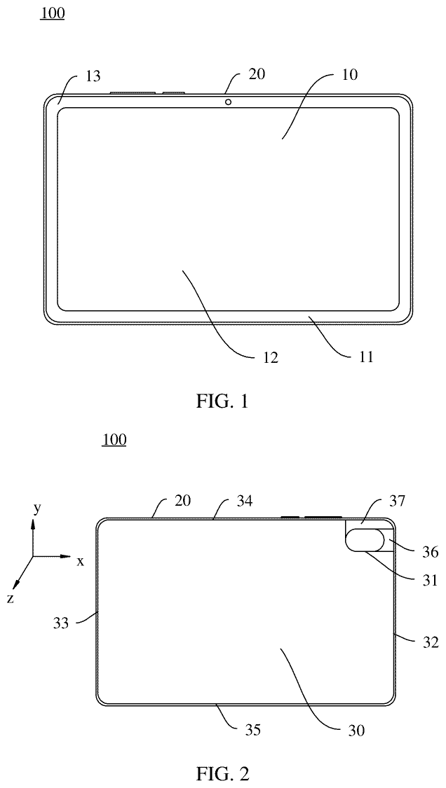

Referring to FIG. 1 and FIG. 2, FIG. 1 is a schematic structural diagram of a front surface of an electronic device according to an embodiment of this application, and FIG. 2 is a schematic structural diagram of a rear surface of an electronic device according to an embodiment of this application. In this embodiment, the electronic device 100 is the tablet computer. The electronic device 100 includes a screen 10, a metal middle frame 20, a metal back housing 30, a rear camera module, and the like.

It may be understood that FIG. 1 and FIG. 2 only schematically show some components included in the electronic device 100, and actual shapes, actual sizes, actual positions, and actual structures of these components are not limited by figures.

The screen 10 is configured to display an image, a video, and the like. The screen 10 includes a light-transmitting substrate, a display screen (English name: panel, also referred to as a display panel), a screen substrate 40, and the like. The light-transmitting substrate, the display screen, and the screen substrate 40 are stacked. The light-transmitting substrate is mainly configured to protect the display screen and prevent dust from falling on the display screen, and the screen substrate 40 supports and protects the display screen. A material of the light-transmitting substrate includes but is not limited to glass, and the screen substrate 40 is a metal plate. The display screen may be a flexible display screen, or may be a rigid display screen. For example, the display screen may be an organic light-emitting diode (organic light-emitting diode, OLED) display screen, an active matrix-organic light-emitting diode (active-matrix organic light-emitting diode, AMOLED) display screen, a mini organic light-emitting diode (mini organic light-emitting diode) display screen, a micro light-emitting diode (micro organic light-emitting diode) display screen, a micro organic light-emitting diode (micro organic light-emitting diode) display screen, a quantum dot light emitting diodes (quantum dot light emitting diodes, QLED) display screen, or a liquid crystal display (liquid crystal display, LCD).

The metal back housing 30 and the metal middle frame 20 are configured to protect an internal electronic component of the electronic device 100. The metal back housing 30 is located on a side that is of the display screen and that is away from the light-transmitting substrate, and is stacked with the light-transmitting substrate, the display screen layer, and the screen substrate 40. The metal middle frame 20 is located between the metal back housing 30 and the light-transmitting substrate. The metal back housing 30 is fastened to the metal middle frame 20. For example, the metal back housing 30 may be fastened to the metal middle frame 20 by using an adhesive, or the metal middle frame 20 and the metal back housing 30 may be an integrally formed structure, that is, the metal middle frame 20 and the metal back housing 30 are an integral structure. The light-transmitting substrate is fixed to the metal middle frame 20 by using an adhesive. The light-transmitting substrate, the metal back housing 30, and the metal middle frame 20 enclose an internal accommodating space of the electronic device 100. The internal accommodating space accommodates the display screen, a camera module, a main board, and a battery.

It should be noted that, in this embodiment of this application, the metal middle frame 20 of the electronic device 100 is made of a metal material, and the metal back housing 30 means that an entire back housing is made of a metal material. The screen 10 of the electronic device 100 includes a display region 12 and a non-display region 11. As shown in FIG. 1, the non-display region 11 is located between the display region 12 and the metal middle frame 20, and the non-display region 11 is commonly referred to as a “black border” on the screen 10. A camera module window for mounting a camera module is provided on the metal back housing 30, so that the camera module can extend out of the metal back housing 30 for photographing. The camera module refers to a rear camera in the electronic device 100. When the camera module window is provided, the camera module window is generally provided close to a corner of the metal back housing 30.

As shown in FIG. 2, the metal back housing 30 includes four sides. A first side 32 and a second side 33 are two opposite sides, and a third side 34 and a fourth side 35 are two opposite sides. For ease of understanding, the first side 32 is a right side of the metal back housing 30 in FIG. 2, the second side 33 is a left side of the metal back housing 30 in FIG. 2, the third side 34 is an upper side of the metal back housing 30 in FIG. 2, and the fourth side 35 is a lower side of the metal back housing 30 in FIG. 2. A corner between the first side 32 and the third side 34 may be referred to as a first corner, and the camera module window is generally provided close to the first corner. Certainly, the first corner is merely an example, and the camera module window may be provided close to other three corners of the metal back housing 30, and operating principles thereof are the same. In this embodiment of this application, the camera module window is provided close to the first corner merely to be consistent with provision positions in most products currently, and more consistent with use habits of a user.

In this embodiment of this application, that the camera module window is provided close to the first corner specifically means that: a distance between the camera module window and the first side 32 is less than a distance between the camera module window and the second side 33; and a distance between the camera module window and the third side 34 is less than a distance between the camera module window and the fourth side 35. In actual application, the distance between the camera module window and the first side 32 is generally much less than the distance between the camera module window and the second side 33; and the distance between the camera module window and the third side 34 is generally much less than the distance between the camera module window and the fourth side 35. For example, a length of the electronic device 100 is 15.5 cm, a width of the electronic device 100 is 8.7 cm, and a size of the camera module window is 3 cm*5 cm. If the distance between the camera module window and the first side 32 is set to 0.5 cm to 1 cm, and the distance between the camera module window and the third side 34 is set to 0.5 cm to 1 cm, the distance between the camera module window and the second side 33 is 9.5 cm to 10 cm, and the distance between the camera module window and the fourth side 35 is 4.7 cm to 5.2 cm. In addition, the size of the electronic device 100 may alternatively be set to 16.3 cm*12.2 cm, 19.9 cm*11.2 cm, 19.7 cm*14.8 cm, 22.4 cm*12.26 cm, or the like. A specific size of the electronic device 100 and a specific size of the camera module window are not limited in this embodiment of this application. The foregoing sizes are merely used for reference, and are mainly used for describing that the camera module window is set close to the corner of the metal back housing 30. A person skilled in the art may set the sizes of the electronic device and the camera module window, and a provision position of the camera module window on the metal back housing 30 according to actual requirements.

It should be noted that, in this embodiment of this application, the distance between the camera module window and the first side refers to a linear distance between a side that is of the camera module window and that is close to the first side and the first side; the distance between the camera module window and the second side is a linear distance between a side of the camera module window close to the second side and the second side; the distance between the camera module window and the third side is a linear distance between a side of the camera module window close to the third side and the third side; and the distance between the camera module window and the fourth side is a linear distance between a side of the camera module window close to the fourth side and the fourth side.

As shown in FIG. 2, because the camera module window is provided close to the first side 32 and the third side 34, the metal back housing 30 forms a narrow region between the first side 32 and the camera module window, which is referred to as a first region 36; and the metal back housing 30 forms a narrow region between the third side 34 and the camera module window, which is referred to as a second region 37.

For ease of description below, an xyz coordinate system is established. A length direction of the electronic device 100 is defined as an x-axis direction, a width direction of the electronic device 100 is defined as a y-axis direction, and a thickness direction of the electronic device 100 is defined as a z-axis direction. It may be understood that a coordinate system of the electronic device 100 may be flexibly set according to actual requirements.

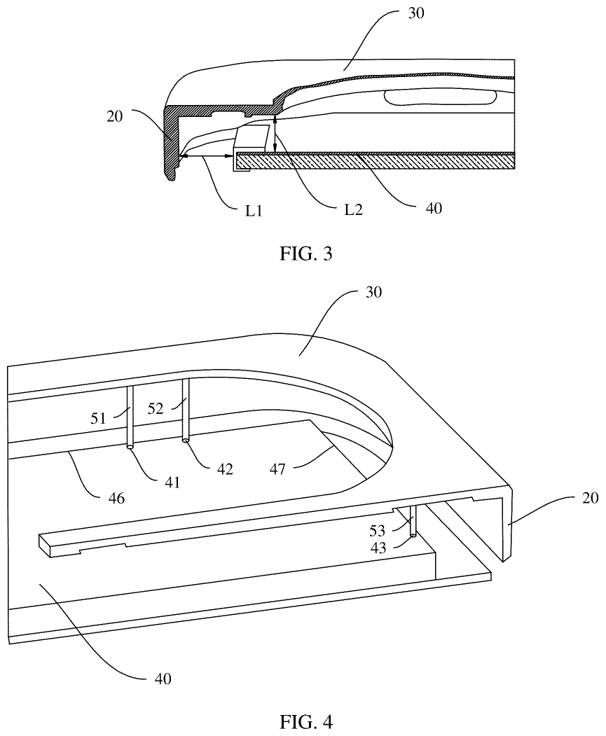

FIG. 3 is a schematic partial cross-sectional view of an electronic device in a thickness direction according to an embodiment of this application. As shown in FIG. 3, the display screen is disposed on the screen substrate 40. A size of the screen substrate 40 on an xy plane may be set to be the same as a size of the display screen on the xy plane. There is a spacing between the screen substrate 40 and the metal middle frame 20, and the spacing is referred to as a first spacing L1. The screen substrate 40 and the metal middle frame 20 maintain the first spacing L1 in both the x-axis direction and the y-axis direction. In other words, there is the first spacing between the display screen and the metal middle frame 20 in both the z-axis direction and the y-axis direction, and a space formed by the first spacing corresponds to a region on the screen 10, that is, the non-display region 11, that is, commonly referred to as the “black border”. It should be noted that, a non-metal part may be disposed in the space formed by the first spacing.

There is a spacing between the screen substrate 40 and the metal back housing 30, and the spacing is referred to as a second spacing L2. The spacing between the screen substrate 40 and the metal back housing 30 is a spacing in the z-axis direction. Another electronic element may be further disposed between the screen substrate 40 and the metal back housing 30. For example, an electronic element such as a main board or a battery may be disposed.

Due to existence of the first spacing and the second spacing, there is a large clearance environment in front of the display screen and behind the display screen, to facilitate antenna design in embodiments of this application.

FIG. 4 is a schematic structural diagram of an antenna according to an embodiment of this application. As shown in FIG. 4, a first ground terminal 41, a second ground terminal 43, and a feed terminal 42 are disposed on the screen substrate 40. The first ground terminal 41, the feed terminal 42, and the second ground terminal 43 are connected to the metal back housing 30 by using metal connectors respectively. Specifically, the first ground terminal 41 on the screen substrate 40 is connected to a first ground point of the metal back housing 30 by using a first ground member 51, the second ground terminal 43 on the screen substrate 40 is connected to a second ground point of the metal back housing 30 by using a second ground member 53, and the feed terminal 42 on the screen substrate 40 is connected to a feed point of the metal back housing 30 by using a feed member 52. The feed terminal 42 is located between the first ground terminal 41 and the second ground terminal 43.

The first ground point may be a projection of the first ground terminal 41 on the metal back housing 30, or the first ground point may be a point near a projection of the first ground terminal 41 on the metal back housing 30. The feed point may be a projection of the feed terminal 42 on the metal back housing 30, or the feed point may be a point near a projection of the feed terminal 42 on the metal back housing 30. The second ground point may be a projection of the second ground terminal 43 on the metal back housing 30, or the second ground point may be a point near a projection of the second ground terminal 43 on the metal back housing 30.

The projections of the first ground terminal 41, the second ground terminal 43, and the feed terminal 42 on the metal back housing 30 are located in the first region 36 and/or the second region 37. Correspondingly, the first ground point, the second ground point, and the feed point on the metal back housing 30 are also located in the first region 36 and/or the second region 37.

It should be noted that, the first region 36 is close to the first side 32 of the metal back housing 30 (one edge of the first region 36 coincides with the first side 32), and the second region 37 is close to the third side 34 of the metal back housing 30 (one edge of the second region 37 coincides with the third side 34). In other words, the first region 36 and the second region 37 are both regions immediately adjacent to the metal middle frame 20 on the metal back housing 30, and the non-display region 11 of the electronic device 100 is an annular region immediately adjacent to the metal middle frame 20 on the screen 10. Generally, in this embodiment of this application, a width of the non-display region 11 may be 0.9 cm to 1 cm, and widths of the first region 36 and the second region 37 are generally 0.5 cm to 1 cm. That is, in the thickness direction (the z-axis direction) of the electronic device 100, projections of the first region 36 and the second region 37 of the metal back housing 30 on the screen 10 may be completely located in the non-display region 11. In other words, in the thickness direction (the z-axis direction) of the electronic device 100, the first region 36 directly faces the non-display region 11, and the second region 37 also directly faces the non-display region 11.

In this embodiment of this application, because the projections of the first ground terminal 41, the second ground terminal 43, and the feed terminal 42 on the metal back housing 30 are located in the first region 36 and/or the second region 37, the first region 36 and the second region 37 directly face the non-display region 11, and four sides of the screen substrate 40 are also edges of the non-display region 11, the first ground terminal 41, the second ground terminal 43, and the feed terminal 42 are also located close to the display region 12 on the screen substrate 40. The widths of the first region 36 and the second region 37 are narrow, and the first ground point, the second ground point, and the feed point are located in the first region 36 and/or the second region 37. Therefore, it may be considered that the first ground point, the second ground point, and the feed point are disposed close to the camera module window. Correspondingly, one end of the first ground member 51, the second ground member 53, and the feed member 52 is disposed close to the non-display region 11, and the other end of the first ground member 51, the second ground member 53, and the feed member 52 is disposed close to the camera module window.

A connection between the screen substrate 40 and the metal back housing 30 is achieved by using the first ground member 51, the second ground member 53, and the feed member 52. The screen substrate 40 and the metal back housing 30 are both metal members. The feed terminal 42 is connected to a radio frequency circuit, to feed a radio frequency signal. In this way, the screen substrate 40 and the metal back housing 30 between the first ground member 51 and the second ground member 53 can form an antenna. A non-display unit and the camera module window are equivalent to two radiation windows, so that the antenna in embodiments of this application is essentially a slot antenna. A window formed by the non-display unit is a first window 13, and a window formed by the camera module window is a second window 31. The first window 13 and the second window 31 facilitate energy radiation performed by the antenna.

In this embodiment of this application, the first ground member 51 and the second ground member 53 of the antenna are equivalent to ground assemblies of the antenna, the feed member 52 of the antenna is configured to feed the antenna, the metal back housing 30 is equivalent to a radiation unit of the antenna, and the screen substrate 40 is equivalent to a ground plane of the antenna.

In an embodiment of this application, a distance between the first ground terminal 41 and the second ground terminal 43 may be set to half a wavelength (0.5 λ), may be set to one wavelength (λ), or may be set to 1.5 wavelengths (1.5 λ), where λ is a wavelength corresponding to an operating frequency of the antenna. A specific size of the antenna may be set based on a size of the electronic device 100. Half a wavelength, one wavelength, and 1.5 wavelengths may refer to a range. For example, half a wavelength may refer to 0.4 λ to 0.6 λ, one wavelength may refer to 0.9 λ to 1. 1 λ, and 1.5 wavelengths may refer to 1.4 λ to 1.6 λ. In this embodiment of this application, the distance is set to 0.5 λ, λ, or 1.5 λ that is a theoretically optimal value thereof. In actual production, the distance cannot be completely accurate to the foregoing value due to a processing error, and the distance may be set to be within a suitable range provided that related performance requirements are satisfied.

It should be noted that, the distance between the first ground terminal 41 and the second ground terminal 43 refers to: a length of a path along which a current flows from the first ground terminal 41 to the second ground terminal 43. For example, the first ground terminal 41 and the second ground terminal 43 are both disposed close to a same side (the third side 34) on the screen substrate 40. In this case, the distance between the first ground terminal 41 and the second ground terminal 43 refers to a linear distance between the first ground terminal 41 and the second ground terminal 43. For another example, the first ground terminal 41 is disposed close to the third side 34 on the screen substrate 40, the second ground is disposed close to the first side 32 on the screen substrate 40, the first side 32 is adjacent to the third side 34, and the two sides form a corner. In this case, the distance between the first ground terminal 41 and the second ground terminal 43 may be understood as: a sum of a linear distance between the first ground terminal 41 and the first side 32 and a linear distance between the second ground terminal 43 and the third side 34. In other words, it may be understood that in this case, the path along which the current flows from the first ground terminal 41 to the second ground terminal 43 is the same as or similar to a path formed by starting from the first ground terminal 41, along the third side 34 and the first side 32 of the screen substrate 40, and ending at the second ground terminal 43.

In this embodiment of this application, an example in which the electronic device 100 is a tablet computer and a distance between the first ground terminal 41 and the second ground terminal 43 in the antenna is set to 0.5 λ is used for description.

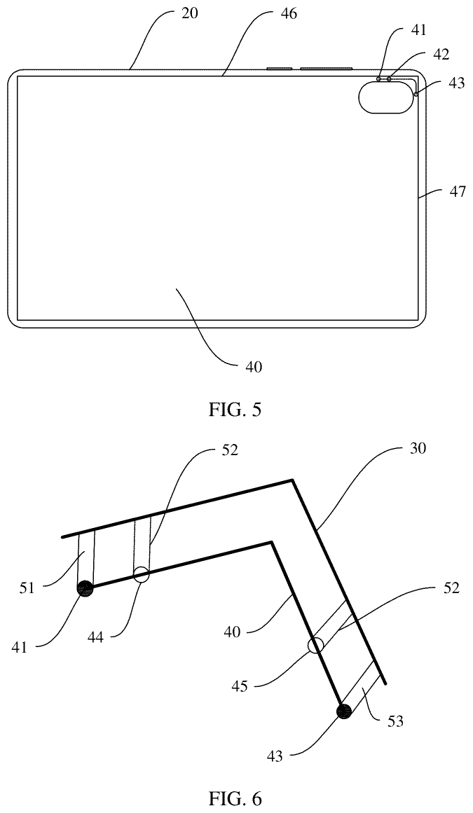

Referring to FIG. 4 and FIG. 5, FIG. 5 is a schematic diagram of an internal structure of an electronic device according to an embodiment of this application. As shown in FIG. 4 and FIG. 5, the first ground terminal 41 is disposed close to a fifth side 46 of the screen substrate 40, and the projection of the first ground terminal 41 on the metal back housing 30 is located in the second region 37 on the metal back housing 30; and the second ground terminal 43 is disposed close to a sixth side 47 of the screen substrate 40, and the projection of the second ground terminal 43 on the metal back housing 30 is located in the first region 36 on the metal back housing 30. The fifth side 46 of the screen substrate 40 and the third side 34 of the metal back housing 30 correspond to each other (are located on a same side), and the sixth side 47 of the screen substrate 40 the first side 32 of the metal back housing 30 correspond to each other (are located on a same side). A path from the first ground terminal 41 to the second ground terminal 43 is shown as a path line in FIG. 5, and a length of the path line is approximately 0.5 λ.

In an embodiment of this application, the feed terminal 42 is disposed close to the fifth side 46 of the screen substrate 40, and the projection of the feed terminal 42 on the metal back housing 30 is located in the second region 37 on the metal back housing 30. It may be understood that a connection line between the feed terminal 42 and the first ground terminal 41 is parallel to the fifth side 46 of the screen substrate 40. A distance between the feed terminal 42 and the ground terminal needs to be determined based on impedance matching of the antenna. For example, the distance between the feed terminal 42 and the ground terminal is determined as the preset distance based on impedance matching of the antenna. A distance between the feed terminal 42 and the first ground terminal 41 may be set to the preset distance, or a distance between the feed terminal 42 and the second ground terminal 43 may be set to the preset distance. As shown in FIG. 5, the distance between the feed terminal 42 and the first ground terminal 41 is set as the preset distance.

In another embodiment of this application, the antenna may further be configured to have a symmetrical structure. Referring to FIG. 4 and FIG. 6, FIG. 6 is a schematic diagram of a simplified model of another antenna according to an embodiment of this application. As shown in FIG. 4, a corner formed by the fifth side 46 and the sixth side 47 on the screen substrate 40 is referred to as a second corner. As shown in FIG. 6, a corner in FIG. 6 is the same as the second corner in FIG. 4. The antennas provided in embodiments of this application are symmetrically disposed about the second corner. Specifically, a distance between the first ground terminal 41 and the sixth side 47 of the screen substrate 40 is equal to a distance between the second ground terminal 43 and the fifth side 46 of the screen substrate 40. The feed terminal 42 may be disposed at a first feed position 44, or may be disposed at a second feed position 45. A linear distance between the first feed position 44 and the first ground terminal 41 is the preset distance, and a linear distance between the second feed position 45 and the second ground terminal 43 is also the preset distance. In actual application, the feed terminal 42 is generally disposed at the first feed position 44. Such disposition helps lay out the feed terminal 42 in the electronic device 100, and facilitates connection of the feed terminal 42 to the radio frequency circuit.

In addition, when the size of the camera module window satisfies a related size requirement of the antenna, specifically, when a length and/or a width of the camera module window is greater than or equal to 0.5 λ, the first ground terminal 41, the feed terminal 42, and the second ground terminal 43 may be disposed on the same side. In other words, when the length of the camera module window is greater than or equal to 0.5 λ, the first ground terminal 41, the feed terminal 42, and the second ground terminal 43 may all be disposed close to the fifth side 46, and the projections of the first ground terminal 41, the feed terminal 42, and the second ground terminal 43 on the metal back housing 30 are all located in the second region 37. Alternatively, when the width of the camera module window is greater than or equal to 0.5 λ, the first ground terminal 41, the feed terminal 42, and the second ground terminal 43 are all disposed close to the sixth side 47, and the projections of the first ground terminal 41, the feed terminal 42, and the second ground terminal 43 on the metal back housing 30 are all located in the first region 36. If the length and the width of the camera module window are both greater than or equal to 0.5 λ, any one of the foregoing disposition manners may be selected for disposition. However, in actual application, generally, the length of the camera module window is greater than the width of the camera module window, and the width of the camera module window is generally less than 0.5 λ.

The length of the camera module window may refer to a total length of the camera module window in the x-axis direction (including lengths of curves at two ends of the camera module window), or may refer to a length of a straight side of the camera module window in the x-axis direction. Similarly, the width of the camera module window may refer to a total width of the camera module window in the y-axis direction (including widths of curves at two ends of the camera module window), or may refer to a width of a straight side of the camera module window in the y-axis direction. Because the size of the camera module window is generally that the length of the camera module window is greater than the width of the camera module window, this embodiment of this application is described by using an example in which the length of the camera module window satisfies a value greater than or equal to 0.5 λ.

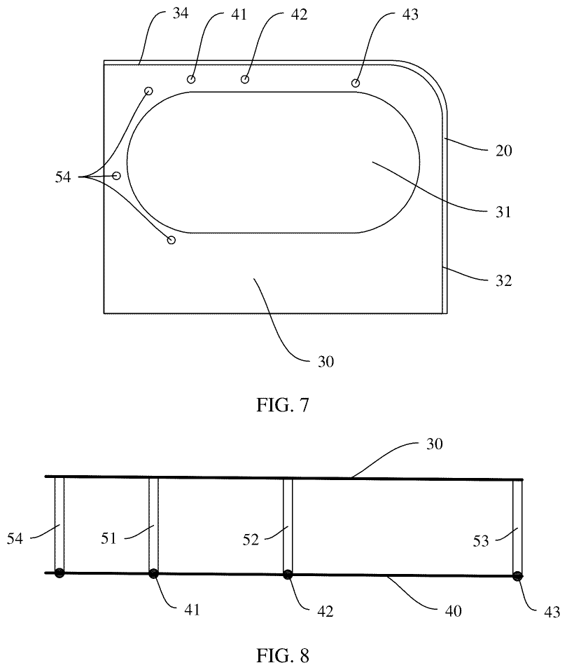

Referring to FIG. 7 and FIG. 8, FIG. 7 is a schematic structural diagram of another antenna according to an embodiment of this application, and FIG. 8 is a schematic diagram of a simplified model of the another antenna shown in FIG. 7 according to an embodiment of this application. As shown in FIG. 7 and FIG. 8, the first ground terminal 41, the feed terminal 42, and the second ground terminal 43 are all disposed close to the fifth side 46 of the screen substrate 40, the first ground terminal 41, the feed terminal 42, and the second ground terminal 43 are located on a straight line, and the feed terminal 42 is located between the first ground terminal 41 and the second ground terminal 43. Because the feed terminal 42, the first ground terminal 41, and the second ground terminal 43 are located on the straight line, as shown in FIG. 7, the distance between the feed terminal 42 and the first ground terminal 41 may be set to the preset distance, or the distance between the feed terminal 42 and the second ground terminal 43 may be set to the preset distance (not shown in the figure).

In an embodiment of this application, the first ground terminal 41, the feed terminal 42, and the second ground terminal 43 are connected to the metal back housing 30 by using metal connectors respectively, to implement transmission of the radio frequency signal. To conveniently implement connections between the first ground terminal 41, the feed terminal 42, and the second ground terminal 43 and the metal back housing 30, the metal connector may be a metal spring contact. Specifically, a first metal spring contact, a second metal spring contact, and a third metal spring contact may be respectively disposed on the screen substrate 40. The first metal spring contact is disposed at a position at which the first ground terminal 41 is located, the second metal spring contact is disposed at a position at which the second ground terminal 43 is located, and the third metal spring contact is disposed at a position at which a third ground terminal is located. The first metal spring contact, the second metal spring contact, and the third metal spring contact separately abut against the metal back housing 30, thereby implementing the connections between the first ground terminal 41, the feed terminal 42, and the second ground terminal 43 and the metal back housing 30.

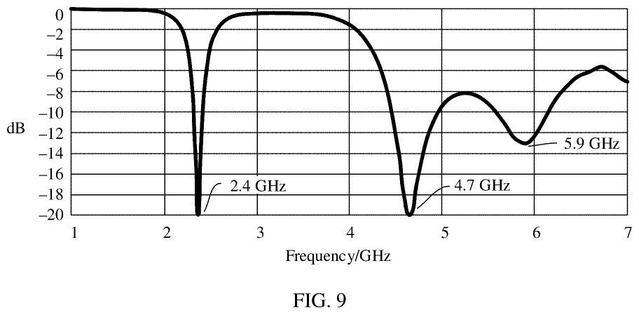

The following describes an operating effect of the antenna solution formed as shown in FIG. 4 with reference to simulation situations shown in FIG. 9 to FIG. 13.

FIG. 9 is a schematic diagram of simulation of the antenna shown in FIG. 4 according to an embodiment of this application. As shown in FIG. 9, it can be learned that the antenna shown in this application may excite at least three resonances, such as a resonance around 2.4 GHz, a resonance around 4.7 GHz, and a resonance around 5.9 GHz. A size of the antenna may be set based on the performance of the antenna, so that the antenna can operate on different frequencies, thereby satisfying different requirements of the electronic device.

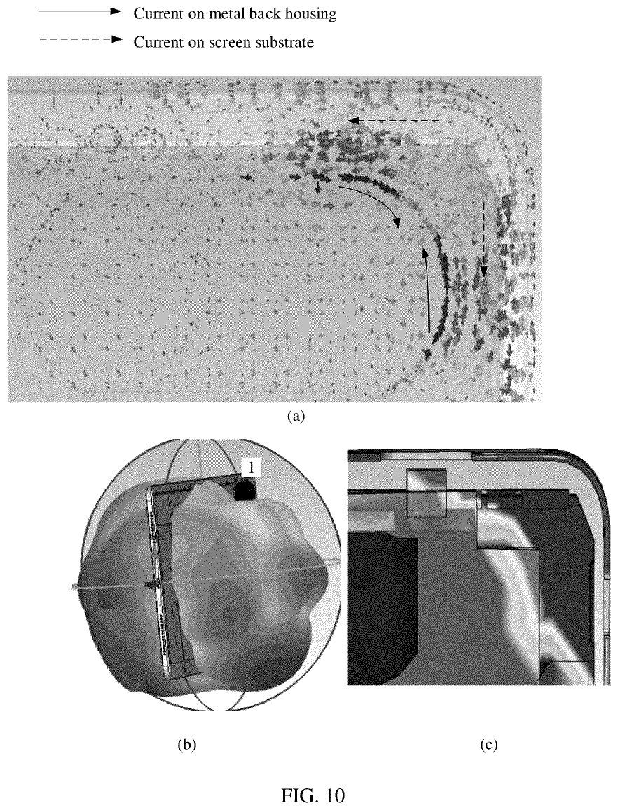

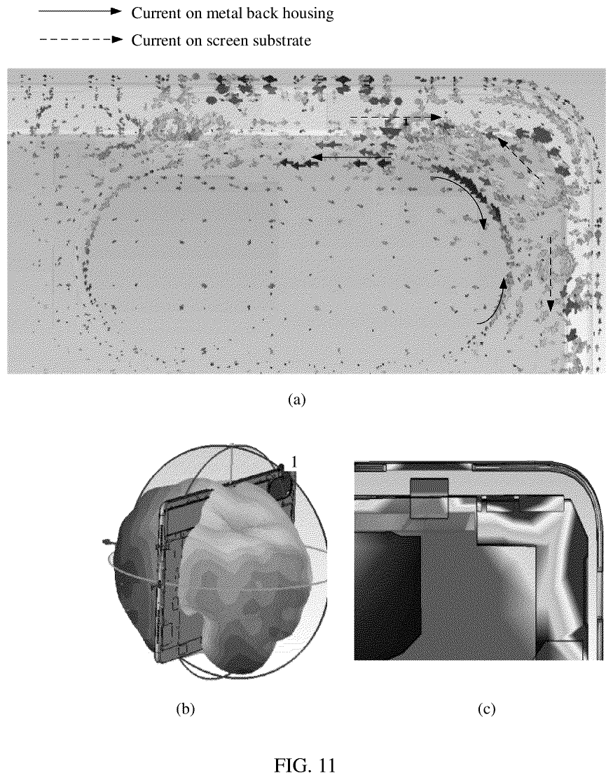

Referring to FIG. 10 to FIG. 12, FIG. 10 is a schematic diagram of current simulation, pattern simulation, and electric field simulation in a Z direction of the antenna shown in FIG. 4 around 2.4 GHz. (a) in FIG. 10 is a schematic diagram of current simulation of the antenna shown in FIG. 4 around 2.4 GHz, (b) in FIG. 10 is a schematic diagram of pattern simulation of the antenna shown in FIG. 4 around 2.4 GHz, and (c) in FIG. 10 is a schematic diagram of electric field simulation in a Z direction of the antenna shown in FIG. 4 around 2.4 GHz. It can be seen from a current simulation result that, a current corresponding to a resonance of 2.4 GHz to an antenna radiator (a metal back housing) is a current distribution shown by solid-line arrows in the figure, and a current on a ground plane (a screen substrate) of the antenna radiator corresponds to a current distribution shown by dashed-line arrows in the figure. In other words, the resonance of 2.4 GHz is a fundamental mode of a ½-wavelength mode. It can be seen from a pattern simulation result that, the antenna has good radiation on both front and rear sides of the electronic device (in front of and behind a screen of a tablet computer), which indicates that the antenna has a low directivity factor. It can be seen from the schematic diagram of the electric field simulation in the Z direction that, the antenna shown in FIG. 4 has high electric field strength at an intermediate position between the first ground terminal and the second ground terminal (a part with a dark color in (c) in FIG. 10).

FIG. 11 is a schematic diagram of current simulation, pattern simulation, and electric field simulation in a Z direction of the antenna shown in FIG. 4 around 4.7 GHz. (a) in FIG. 11 is a schematic diagram of current simulation of the antenna shown in FIG. 4 around 4.7 GHz, (b) FIG. 11 is a schematic diagram of pattern simulation of the antenna shown in FIG. 4 around 4.7 GHz, and (c) in FIG. 11 is a schematic diagram of electric field simulation in a Z direction of the antenna shown in FIG. 4 around 4.7 GHz. It can be seen from a current simulation result that, a current corresponding to a resonance of 4.7 GHz to an antenna radiator (a metal back housing) is a current distribution shown by a solid-line arrow in the figure, and a current on a ground plane (a screen substrate) of the antenna radiator corresponds to a current distribution shown by a dashed-line arrow in the figure. In other words, the resonance of 4.7 GHz is a fundamental mode of a 1-wavelength mode. It can be seen from a pattern simulation result that, the antenna has good radiation on both front and rear sides of the electronic device (in front of and behind a screen of a tablet computer), which indicates that the antenna has a low directivity factor. It can be seen from the schematic diagram of the electric field simulation in the Z direction that, the antenna shown in FIG. 4 has high electric field strength between the first ground terminal and the second ground terminal (a part with a dark color in (c) FIG. 11).

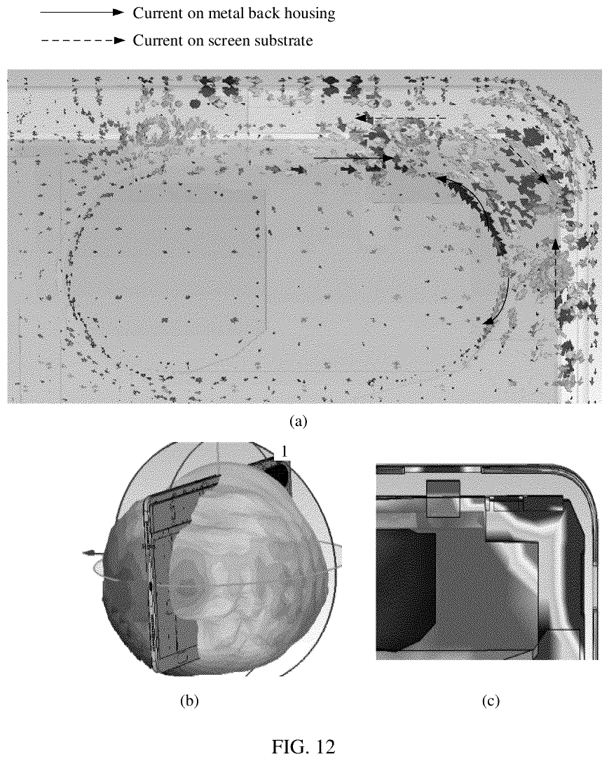

FIG. 12 is a schematic diagram of current simulation, pattern simulation, and electric field simulation in a Z direction of the antenna shown in FIG. 4 around 5.9 GHz. (a) in FIG. 12 is a schematic diagram of current simulation of the antenna shown in FIG. 4 around 5.9 GHz, (b) in FIG. 12 is a schematic diagram of pattern simulation of the antenna shown in FIG. 4 around 5.9 GHz, and (c) in FIG. 12 is a schematic diagram of electric field simulation in a Z direction of the antenna shown in FIG. 4 around 5.9 GHz. It can be seen from a current simulation result that, a current corresponding to a resonance of 5.9 GHz to an antenna radiator (a metal back housing) is a current distribution shown by a solid-line arrow in the figure, and a current on a ground plane (a screen substrate) of the antenna radiator corresponds to a current distribution shown by a dashed-line arrow in the figure. In other words, the resonance of 5.9 GHz is a fundamental mode of a 1.5-wavelength mode. It can be seen from a pattern simulation result that, the antenna has good radiation on both front and rear sides of the electronic device (in front of and behind a screen of a tablet computer), which indicates that the antenna has a low directivity factor. It can be seen from the schematic diagram of the electric field simulation in the Z direction that, the antenna shown in FIG. 4 has high electric field strength between the first ground terminal and the second ground terminal (a part with a dark color in (c) in FIG. 12).

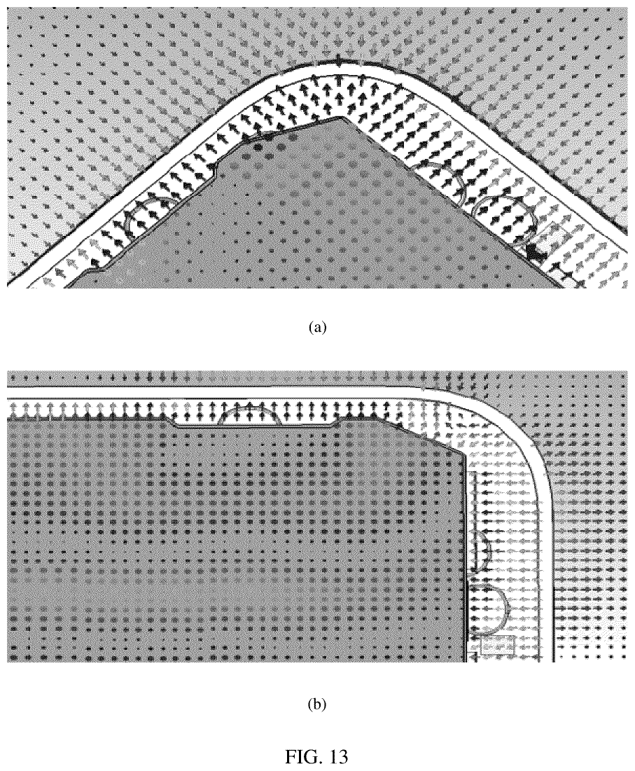

FIG. 13 is a radiation aperture diagram of an electric field distribution of the antenna shown in FIG. 4 in front of a screen of an electronic device. (a) in FIG. 13 is a radiation aperture diagram of an electric field distribution in front of a screen of an electronic device when an antenna operates at a low frequency; and (b) in FIG. 13 is a radiation aperture diagram of an electric field distribution in front of a screen of an electronic device when an antenna operates at a high frequency. The low frequency may refer to operating around 2.4 GHZ, and the high frequency may refer to operating around 4.7 GHz. (a) in FIG. 13 corresponds to (c) in FIG. 10, and (b) in FIG. 13 corresponds to (c) in FIG. 11. Arrows in (a) and (b) in FIG. 13 both indicate a direction of a current, and a shade of the arrow indicates strength of the current.

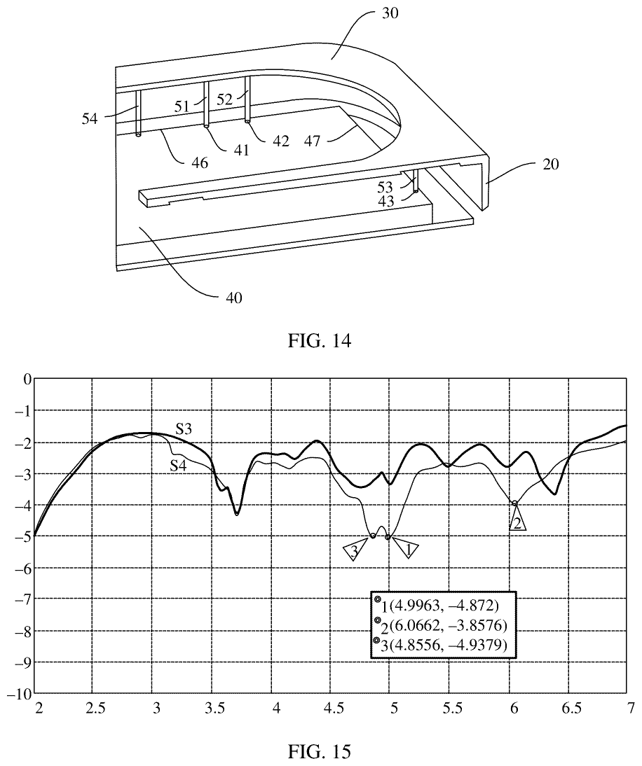

In an embodiment of this application, referring to FIG. 7, FIG. 8, and FIG. 14, FIG. 14 is another schematic structural diagram of an antenna according to an embodiment of this application. As shown in FIG. 7, FIG. 8, and FIG. 14, in the antenna, a fourth metal spring contact 54 may further be disposed on a side that is of the first ground terminal 41 and that is away from the feed, and the fourth metal spring contact 54 (not shown in the figure) may further be disposed on a side that is of the second ground terminal 43 and that is away from the feed, where a quantity of fourth metal spring contacts 54 may be one or more. The fourth metal spring contact 54 abuts against the metal back housing 30, and each fourth metal spring contact 54 is grounded. Because parts that are of the metal back housing 30 and the screen substrate 40 and that are mainly located between the first ground terminal 41 and the second ground terminal 43 are used to form the antenna, other parts of metal plates on the metal back housing 30 and the screen substrate 40 may be grounded by disposing a plurality of fourth metal spring contacts 54, to eliminate impact of some clutters on the antenna, thereby improving performance of the antenna.

FIG. 15 is a radiation efficiency curve diagram of whether an antenna is added with a fourth spring contact according to an embodiment of this application. As shown in FIG. 15, a curve S3 in FIG. 15 is a curve diagram in which a fourth spring contact is added, and a curve S4 in FIG. 15 is a curve diagram in which a fourth spring contact is not added. In the curve S4, clutters are generated on three frequencies, thereby affecting radiation efficiency of the antenna. It can be seen from the figure, radiation efficiency of the antenna added with the fourth spring contact is better than that of the antenna not added with the fourth spring contact.

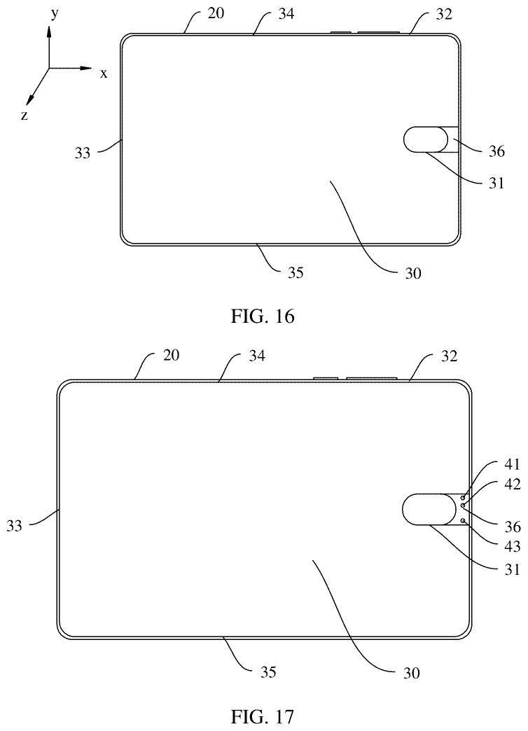

In an embodiment of this application, an electronic device is further provided. FIG. 16 is a schematic structural diagram of a rear surface of another electronic device according to an embodiment of this application. As shown in FIG. 16, a difference between the electronic device shown in FIG. 16 and the electronic device shown in FIG. 2 lies in that: provision positions of the camera module windows are different. The camera module window shown in FIG. 2 is disposed close to the first side and the third side, and the camera module window shown in FIG. 16 is disposed close to the first side and is centered in a width direction of the electronic device. In other words, in FIG. 16, a distance between the camera module window and the first side is less than a distance between the camera module window and the second side, and a distance between the camera module window and the third side is equal to a distance between the camera module window and the fourth side. In actual application, the distance between the camera module window and the first side may be set to 0.5 cm to 1 cm.

FIG. 17 is a schematic structural diagram of another antenna according to an embodiment of this application. As shown in FIG. 17, the projections of the first ground terminal, the second ground terminal, and the feed terminal of the antenna on the metal back housing are located between the camera module window and the first side. Specifically, for disposition of the antenna, refer to disposition of the antenna shown in FIG. 7, and details are not described herein again. A difference lies in that a disposition position of the antenna is different from a provision position of the camera module window. The antenna may be used in the electronic device shown in FIG. 16.

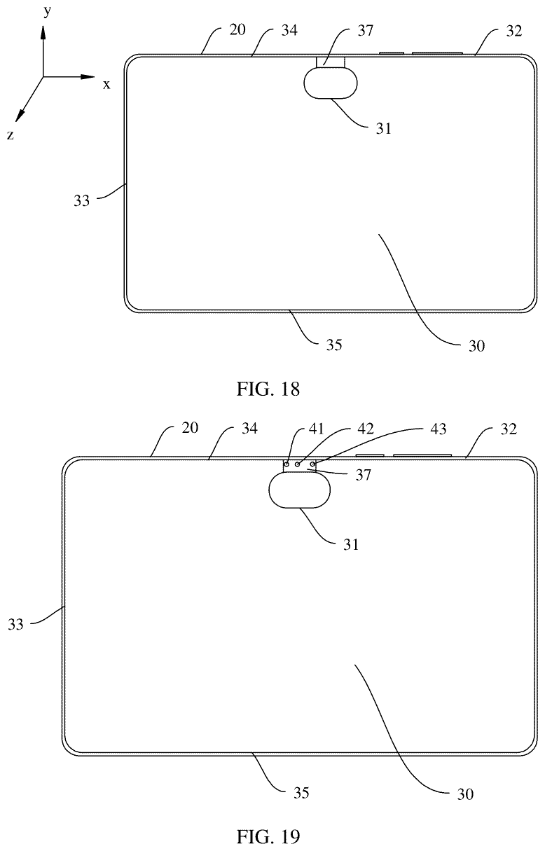

In an embodiment of this application, an electronic device is further provided. FIG. 18 is a schematic structural diagram of a rear surface of still another electronic device according to an embodiment of this application. As shown in FIG. 18, a difference between the electronic device shown in FIG. 18 and the electronic device shown in FIG. 2 lies in that: provision positions of the camera module windows are different. The camera module window shown in FIG. 2 is disposed close to the first side and the third side, and the camera module window shown in FIG. 18 is disposed close to the third side and is centered in a length direction of the electronic device. In other words, in FIG. 18, a distance between the camera module window and the third side is less than a distance between the camera module window and the fourth side, and a distance between the camera module window and the first side is equal to a distance between the camera module window and the second side. In actual application, the distance between the camera module window and the third side may be set to 0.5 cm to 1 cm.

It should be noted that, equality in embodiments of this application not only includes theoretical complete equality, but also includes approximate equality. For example, the distance between the camera module window and the third side is slightly less than the distance between the camera module window and the fourth side, or the distance between the camera module window and the third side is slightly greater than the distance between the camera module window and the fourth side, and an error range is ±10%.

FIG. 19 is a schematic structural diagram of still another antenna according to an embodiment of this application. As shown in FIG. 19, the projections of the first ground terminal, the second ground terminal, and the feed terminal of the antenna on the metal back housing are located between the camera module window and the first side. Specifically, for disposition of the antenna, refer to disposition of the antenna shown in FIG. 7, and details are not described herein again. A difference lies in that a disposition position of the antenna is different from a provision position of the camera module window. The antenna may be used in the electronic device shown in FIG. 18.

It should be noted that, a fourth metal spring contact 54 may also be disposed in the antennas shown in FIG. 17 and FIG. 19. Specifically, for disposition of the fourth metal spring contact 54, refer to relevant descriptions of the foregoing embodiments, and details are not described herein again.

The foregoing descriptions are merely specific implementations of this application, but the protection scope of this application is not limited thereto. Any variation or replacement readily figured out by a person skilled in the art within the technical scope disclosed in this application shall fall within the protection scope of this application.

The various embodiments in this specification are all described in a progressive manner. Descriptions of each embodiment focus on differences from other embodiments, and same or similar parts among the various embodiments may be mutually referenced.

Although preferred embodiments of embodiments of this application have been described, a person skilled in the art can make other changes and modifications to these embodiments once they know the basic creative concept of this application. Therefore, the protection scope of this application includes the preferred embodiments and all changes and modifications falling within the scope of embodiments of this application.

The antenna and the electronic device provided in this application are described in detail above. The principle and implementations of this application are described in this specification by using specific examples. The descriptions of the foregoing embodiments are merely used for helping understand transmission circuits and core ideas of this application. Meanwhile, a person of ordinary skill in the art may make modifications to the specific implementations and application scopes according to the ideas of this application. In conclusion, the content of the specification should not be construed as a limitation to this application.

The foregoing content is merely specific implementations of this application. However, the protection scope of this application is not limited thereto. Any variation or replacement within the technical scope disclosed in this application shall fall within the protection scope of this application. Therefore, the protection scope of this application shall be subject to the protection scope of the claims.

What is claimed is:

1. An antenna, used in an electronic device, wherein the electronic device comprises a metal back housing, a metal middle frame, and a screen substrate, wherein the screen substrate is a metal plate, the metal back housing is connected to the metal middle frame, the screen substrate has a first spacing with the metal middle frame, the screen substrate has a second spacing with the metal back housing, the first spacing between the screen substrate and the metal middle frame forms a first window, and a second window is provided on the metal back housing;
the metal back housing comprises a first side and a second side opposite to each other, and a third side and a fourth side opposite to each other, the first side is adjacent to the third side, a region between the first side and the second window is a first region, and a region between the third side and the second window is a second region;
a distance between the second window and the first side is less than a distance between the second window and the second side, and/or a distance between the second window and the third side is less than a distance between the second window and the fourth side;
a first ground terminal, a feed terminal, and a second ground terminal are disposed on the screen substrate, the feed terminal is located between the first ground terminal and the second ground terminal, and projections of the first ground terminal, the feed terminal, and the second ground terminal on the metal back housing are located in the first region and/or the second region; and
the first ground terminal, the feed terminal, and the second ground terminal are connected to the metal back housing by using metal connectors respectively.

2. The antenna according to claim 1, wherein the antenna comprises the first ground terminal, the feed terminal, and the second ground terminal, and the first ground terminal and the second ground terminal is configured for grounding, the feed terminal is configured to feed the antenna, the metal back housing is a radiation unit of the antenna, and the screen substrate is a ground plane of the antenna.

3. The antenna according to claim 1, wherein the first window is a non-display region of a screen of the electronic device.

4. The antenna according to claim 1, wherein the second window is a camera module window of the electronic device.

5. The antenna according claim 1, wherein a distance between the first ground terminal and the second ground terminal is half a wavelength, one wavelength, or 1.5 wavelengths, and the wavelength is a wavelength corresponding to an operating frequency of the antenna.

6. The antenna according claim 1, wherein a distance between the feed terminal and the first ground terminal is a preset distance, or a distance between the feed terminal and the second ground terminal is a preset distance; and the preset distance is determined based on impedance matching of the antenna.

7. The antenna according to claim 1, wherein the projections of the first ground terminal, the feed terminal, and the second ground terminal on the metal back housing are all located in the first region; and
a length of the second window in a direction of the first side is greater than or equal to the distance between the first ground terminal and the second ground terminal.

8. The antenna according claim 1, wherein the projections of the first ground terminal, the feed terminal, and the second ground terminal on the metal back housing are all located in the second region; and
a length of the second window in a direction of the third side is greater than or equal to the distance between the first ground terminal and the second ground terminal.

9. The antenna according claim 1, wherein the projections of the first ground terminal and the feed terminal on the metal back housing are located in the second region, and the projection of the second ground terminal on the metal back housing is located in the first region.

10. The antenna according claim 1, wherein the projection of the first ground terminal on the metal back housing is located in the second region, and the projections of the second ground terminal and the feed terminal on the metal back housing are located in the first region.

11. The antenna according to claim 1, wherein the screen substrate comprises a fifth side and a sixth side adjacent to each other, the fifth side corresponds to the third side, and the sixth side corresponds to the first side; and
a distance between the first ground terminal and the sixth side is equal to a distance between the second ground terminal and the fifth side.

12. The antenna according claim 2, wherein a first metal spring contact is disposed at the first ground terminal, and the first metal spring contact abuts against the metal back housing; a second metal spring contact is disposed at the feed terminal, and the second metal spring contact abuts against the metal back housing; and a third metal spring contact is disposed at the second ground terminal, and the third metal spring contact abuts against the metal back housing.

13. The antenna according to claim 12, wherein one or more fourth metal spring contacts are further disposed on the screen substrate, the fourth metal spring contact is located on a side that is of the first metal spring contact and that is away from the second metal spring contact, and/or the fourth metal spring contact is located on a side that is of the third metal spring contact and that is away from the second metal spring contact; and
the fourth metal spring contact is grounded and abuts against the metal back housing.

14. An electronic device, comprising a metal back housing, a metal middle frame, and a screen substrate, wherein the screen substrate is a metal plate, the metal back housing is connected to the metal middle frame, the screen substrate has a first spacing with the metal middle frame, the screen substrate has a second spacing with the metal back housing, the first spacing between the screen substrate and the metal middle frame forms a first window, and a second window is provided on the metal back housing;
the metal back housing comprises a first side and a second side opposite to each other, and a third side and a fourth side opposite to each other, the first side is adjacent to the third side, a region between the first side and the second window is a first region, and a region between the third side and the second window is a second region;
a distance between the second window and the first side is less than a distance between the second window and the second side, and/or a distance between the second window and the third side is less than a distance between the second window and the fourth side;
a first ground terminal, a feed terminal, and a second ground terminal are disposed on the screen substrate, the feed terminal is located between the first ground terminal and the second ground terminal, and projections of the first ground terminal, the feed terminal, and the second ground terminal on the metal back housing are located in the first region and/or the second region; and
the first ground terminal, the feed terminal, and the second ground terminal are connected to the metal back housing by using metal connectors respectively.

15. The electronic device according to claim 14, wherein the electronic device further comprises a display screen, wherein the display screen is connected to the metal middle frame, and the display screen and the metal back housing are respectively located on two sides of the metal middle frame.

16. The antenna according to claim 14, wherein the first window is a non-display region of a screen of the electronic device.

17. The antenna according to claim 14, wherein the second window is a camera module window of the electronic device.

18. The antenna according claim 14, wherein a distance between the first ground terminal and the second ground terminal is half a wavelength, one wavelength, or 1.5 wavelengths, and the wavelength is a wavelength corresponding to an operating frequency of the antenna.

19. The antenna according claim 14, wherein a distance between the feed terminal and the first ground terminal is a preset distance, or a distance between the feed terminal and the second ground terminal is a preset distance; and the preset distance is determined based on impedance matching of the antenna.

20. The antenna according to claim 14, wherein the projections of the first ground terminal, the feed terminal, and the second ground terminal on the metal back housing are all located in the first region; and
a length of the second window in a direction of the first side is greater than or equal to the distance between the first ground terminal and the second ground terminal.
